(19) United States
(12) Patent Application Publication
(10) Pub. No.: US 2020/0189898 A1
(43) Pub. Date: Jun. 18, 2020

(54) CONTAINER HANDLING MACHINE, SUCH AS A CONTAINER FILLING MACHINE OR CONTAINER CLOSING MACHINE, AND A METHOD OF OPERATION THEREOF

(71) Applicants: Alexandra THEOPOLD, Dortmund (DE); Wilfried EHMER, Dortmund (DE)

(72) Inventors: Alexandra THEOPOLD, Dortmund (DE); Wilfried EHMER, Dortmund (DE)

(21) Appl. No.: 16/692,210

(22) Filed: Nov. 22, 2019

Related U.S. Application Data
(63) Continuation-in-part of application No. PCT/EP2018/062556, filed on May 15, 2018.

(30) Foreign Application Priority Data
May 22, 2017 (DE) 102017111066.6

(51) Int. Cl. B67C 3/28; B67C 7/00

(52) U.S. Cl. CPC B67C 3/282; B67B 3/00; B67C 7/0046

(57) ABSTRACT

A container handling machine, such as a container filling machine or container closing machine, and a method of operation thereof. The abstract of the disclosure is submitted herewith as required by 37 C.F.R. § 1.72(b). As stated in 37 C.F.R. § 1.72(b): A brief abstract of the technical disclosure in the specification must commence on a separate sheet, preferably following the claims, under the heading “Abstract of the Disclosure.” The purpose of the abstract is to enable the Patent and Trademark Office and the public generally to determine quickly from a cursory inspection the nature and gist of the technical disclosure. The abstract shall not be used for interpreting the scope of the claims. Therefore, any statements made relating to the abstract are not intended to limit the claims in any manner and should not be interpreted as limiting the claims in any manner.

This application is a Continuation-In-Part application of International Patent Application No. PCT/EP2018/215245, filed on May 15, 2018, which claims priority from Federal Republic of Germany Patent Application No. 10 2017 111 066.6, filed on May 22, 2017. International Patent Application No. PCT/EP2018/215245 was pending as of the filing date of this application. The United States was an elected state in International Patent Application No. PCT/EP2018/215245.

### BACKGROUND

### 1. Technical Field

The present application relates to a container handling machine, such as a container filling machine or container closing machine, and a method of operation thereof.

### 2. Background Information

Background information is for informational purposes only and does not necessarily admit that subsequently mentioned information and publications are prior art.

Container manufacturing plants and machines thereof are used to manufacture containers, such as bottles, cans, jars, boxes, pouches, bags, kegs, and other such containers, with products for consumption by consumers. Such container manufacturing plants include at least a container filling machine to fill the containers and a container closing machine to close the containers. The container filling machine is often a rotary filling machine with a plurality of container filling devices located on the periphery of a rotor or carousel. Each container filling device is designed to fill a container with a product, such as a liquid product or a solid product, while the rotor rotates and moves the containers. The container filling devices are usually designed to introduce a predetermined amount of product into the interior of each container.

After the containers have been filled they are transported or conveyed to a container closing machine, which is also often a rotary closing machine. There may further be provided a conveyor arrangement configured to transfer containers from the filling machine to the closing machine. A transporting or conveying arrangement can utilize transport star wheels as well as linear conveyors. A closing machine closes containers by applying a closure to an opening in the container, or by closing or sealing an opening in the container. Closed containers are then usually conveyed to an information adding arrangement, wherein information, such as a product name or a manufacturer's information or logo, is applied to a container.

Most container filling plants are controlled by a central control arrangement that monitors and controls the operation of the various container handling and treatment machines, as well as inspection, detection, and monitoring arrangements. The present application also relates to a method for monitoring a process on a machine, and to a machine with such process monitoring, such as processes and machine for container filling, or possibly for other uses, such as in an industrial or commercial setting.

As discussed above, there exist devices for the treatment or handling of containers. These container handling devices often are rotational machines that comprise a rotating transport element (hereinafter also referred to as a rotor). The rotating transport element has a plurality of container treatment stations, each of which includes at least one container handling or treatment element, such as a container filling or closing device, to act directly or indirectly on the containers. At these stations, the handling or production of the containers can be carried out during the rotation of the rotor, such that the containers are simultaneously or substantially simultaneously transported along a transport path. It should be noted at this time that while the application discusses the implementation of the device and method of monitoring in the context of a container filling plant, the device and method could be implemented with a variety of types of devices in commercial, industrial, public, or private settings in which there are repeated process steps or machines with identical or essentially identical design and/or function. Therefore, any discussion of containers herein should be understood as relating to many types of products and workpieces made or treated or handled in a repeated process in a variety of settings.

The container handling stations and devices provided there, for example, exhibit in each case an identical or essentially identical structure, and the processes carried out at the container handling stations are identical or essentially identical. Due to the temporally offset or staggered delivery and removal of the containers respectively, the processes or process steps at the respective container handling stations are carried out temporally staggered in relation to one another, or are at different stages of the same process or process step, such that, for example, a second container handling station that is running behind a first container handling station carries out the same process as the first container handling station, but with a time delay in relation to it. As a rule, the same process or process step of each container handling station is carried out at the same place of the device, for example in a defined angle range of a rotating device.

A problem of this situation is the fact that process monitoring at the respective container handling stations is difficult, for example, when a high throughput of containers are to be treated or produced. It is frequently the case that monitoring of the handling of the containers only or sometimes takes place subsequently, for example in an inspection unit that follows after the container handling machine in the transport direction.

### Object or Objects

An object of the present application is to provide a container handling machine and method of operating a container handling machine.

### SUMMARY

According to a first aspect, the present application relates to container handling machines, as well as to a method for monitoring the handling or treatment of containers. As discussed herein, container handling machines utilize transport arrangements to move the containers along a transport path while the containers are being treated, such as being filled or closed or other processes. The transport arrangements are often in the form of a rotary transport arrangement or rotor with a plurality of container handling stations disposed about or on the periphery or circumference thereof. As an alternative, the transport arrangement can be formed by an enclosed transport path in the form of rails or guide structures, provided on which are transport elements that can be moved independently of one another. The container handling stations comprise in each case at least one container handling or treatment device designed to act directly or indirectly on the containers while the containers are moved along a transport path between an inlet and an outlet. The handling or treatment of the containers performed between the inlet and the outlet can be any of various known handling or treatment processes, such as forming of containers, cleaning or rinsing, filling with a product, closing or capping or sealing, labeling or adding information, and wrapping or packaging.

In container filling plants, since there are multiple container handling machines that have different functions, monitoring devices are used to monitor the performance of the container handling machines. These monitoring devices can be in the form of different types of sensors that can be used to monitor and detect most all aspects of the operation of the container handling machines, as well as the characteristics of the containers themselves. It is common to use monitoring devices to detect the characteristics of the containers after they have been handled by a container handling machine. For example, after a container has been filled in a filling machine, a monitoring device may be used to check the fill level of the containers to determine in the containers are being filled to the desired level. Any improperly-filled containers are then ejected from the processing stream. Errors in the containers are usually the result of improper or erroneous performance of the related machinery, such as the individual filling devices. The present application describes an apparatus and method in which the monitoring device can perform the monitoring while the handling or treatment process is occurring, notably at each individual handling or treatment device of a handling machine. For example, in one possible exemplification, for a rotary container filling machine, monitoring devices are placed at each of the individual container filling devices on the periphery of the rotor. These monitoring devices can be used to monitor the operation of the filling devices to determine if one or more filling devices is operating improperly, or is exhibiting signs that the filling device may soon begin to operate improperly or outside of acceptable operating tolerances. This pre-emptive detection can help minimize loss of product and downtime for repairs.

In at least one possible exemplification, in order to perform the monitoring of discrete components and/or sub-parts thereof or spare parts of container handling or treatment machines, the container handling or treatment machines comprise at least one sensor device for detecting an oscillation frequency and/or an acoustic signal, by which a pattern is detected that is produced by the container handling or treatment or production process at the respective container handling or treatment station and during the transport of the containers at this treatment station. In this context, hereinafter the term “pattern” should be understood to mean an oscillation and/or an acoustic signal, or its physically measurable amplitude or strength and/or frequency or frequency response over a period of time, which is limited in one possible exemplification. Again, it should be noted that the apparatus and method disclosed herein, according to one exemplification, not only relate to the handling and/or treatment of containers, but also relate to the handling and/or treatment of other objects or products, which are collectively referred to herein as “workpieces,” by any variety of machines that perform repeated handling and/or treatment processes, aspects of which can be monitored and/or detected to determine a pattern of vibrations or oscillations or sounds.

The measured signal, measured signal characteristic, or a signal derived from these, is then evaluated and compared with a reference signal or a reference signal range. This characteristic is the inherent, physical emission of the functional elements themselves, such as, for example, the closing of a valve, reaching of one end position of a lever arm, closing of gripper arms on a container surface, the sound of gear wheels, and/or the sound produced by the flow of product through the inner canals or channels. Hereinafter the term “reference signal” may also be understood as a reference signal range. It may also be understood as a dynamic reference signal, which results from the average signal of a number of equal or identical or similar functional elements, as mentioned herein above. The process monitoring in this situation in one possible exemplification relates not to the transfer process of a holding and centering unit which can be detachably secured to the treatment station, by which a container is held and then passed on from one rotor to another following rotor.

Rather, the process monitoring relates, for example, to mechanical switching and placement procedures, as well as process steps, that are begun after the workpiece, such as a container or other object to be processed or treated in some manner, has been brought into the treatment station (i.e. after the inlet) and end before the workpiece is removed from the treatment station of the transport element. The patterns that are produced in this situation are created at least partially by one or more functional elements, that are integral component parts of the treatment station, and which, during the process, being monitored are not released from the treatment station or introduced into it. In this situation, the present application expressly encompasses the fact that the process monitoring can extend over a plurality of transport elements (e.g. rotors) of the machine, but the process monitoring takes place in each case for process steps that are carried out between the inlet and the outlet of the respective transport elements.

In at least one possible exemplification of the present application, errors or abnormalities in the course of the process may be identified at an early stage such that high repair costs and lengthy machine downtimes can be counteracted. Rather, a proactive and forward-looking machine maintenance and repair procedure can be initiated when the process is still running within tolerable process limits. It is also possible, based on the measurement signals detected by the sensors, for an adjustment of process parameters to be carried out (i.e. the process is controlled or modified depending on the measurement signals), such that, for example, the output of treated containers can be reduced.

According to one possible exemplification, the pattern is detected in a time range in which the workpiece is moved over at least a quarter, and in one possible exemplification at least half, of the transport path between the inlet and the outlet. This allows for an optimized process monitoring of the treatment process being applied on the machine, since a large number of process steps that are completed during the run of the workpiece from the inlet to the outlet can be detected by the sensors.

According to one possible exemplification, the pattern is formed at one or more functional elements that are provided at the treatment station and which throughout the entire process are not released from the treatment station. In other words, the functional elements, which are the cause of the acoustic or mechanical oscillations, are integral component parts of the treatment station (i.e. they are not removed from it throughout the entire process). As a result, the acoustic or mechanical oscillations of the functional elements of the respective treatment stations can be picked up by the sensors and drawn on for the process monitoring. Such functional elements can be, for example, constituent parts of the treatment stations, that act directly or indirectly on the workpieces, such as, for example, a milling head, a drill, a valve flap, a valve body, a drive unit, a holding tulip or closure tulip for a container, a closing tool, for example for a crown cork, or a screw closure, sealing chucks, and many more possibilities.

According to one possible exemplification, the pattern is caused by at least one location change of a functional element or a part thereof. For example, this can be a raising or lowering of a functional element, for example of a valve body or a closing tool. As a result, the change of position of a functional element can be detected by the process monitoring.

According to one possible exemplification, the pattern comprises an oscillation frequency and/or an acoustic signal, which occurs when the functional element or a part thereof reach an at least temporary end position. For example, when the functional element is raised or lowered, it can move to a stop element, and the action of the functional element being brought in contact with this stop element is detected by the process monitoring.

According to one possible exemplification, the pattern comprises an oscillation frequency and/or an acoustic signal, which occur when there is a spatial change of location of the functional element or a part thereof. The change of location can be incurred in one possible exemplification by a translational or rotational movement of a functional element or a part thereof.

According to one possible exemplification, the process carried out at the transport element, in at least one possible exemplification at one single transport element (filling, closing, labeling, etc.) comprises several part processes, wherein the patterns produced during these part processes are detected by one single sensor or by a group of several sensors provided at the respective treatment station. In this situation, the sensors can be positioned at the treatment station in such a way, or distributed at different positions in the treatment station in such a way, that oscillations occurring at different functional elements of the treatment station can be detected in an improved manner.

According to one possible exemplification, the same process steps or same part processes at different treatment stations in each case are carried out in specific regions of the transport path between the inlet and the outlet, or the same processes or same part processes are carried out at different treatment stations between the inlet and the outlet staggered in time in relation to one another. In other words, the different part processes are carried out at least partially at different rotational positions of a transport element that is driven such as to rotate about an axis of rotation. The rotational positions of the transport element lie in one possible exemplification at rotational settings in the region between the inlet and outlet on this transport element. In this situation, the same part processes of the treatment stations may be carried out at the same place and/or location of the machine (i.e. at the arrangement of the treatment station on a rotor the respective same part processes may be carried out in the same angle range of the rotor) and with a constant or substantially constant transport speed, also in the same time frame after a workpiece has been taken over at the respective treatment station.

According to one possible exemplification, the measurement signals at two or more treatment stations are detected simultaneously or substantially simultaneously. In other words, a time-overlapping process monitoring is carried out at the treatment stations, wherein the treatment stations or their functional elements are essentially of the same structural design.

According to one possible exemplification, the reference signal is initially determined on the basis of several measurement signals detected at different treatment stations, predominantly staggered in time, which are likewise essentially of the same structural design. For example, a reference signal is calculated from measurement signals from different treatment stations, possibly by time and/or value averaging. This averaging can be carried out by making use of weighting factors, such that the measurement signals can be weighted relative to one another. Accordingly, when determining the reference signal, use can possibly be made of the fact that the processes of the same type that are carried out at the plurality of treatment stations lead in most cases to identical or very similar measurement signals at the sensors. This fact can be drawn on for the determination of the reference signal or for the evaluation of measurement signals that exhibit peculiarities.

In at least one possible exemplification of the present application, during the formation of the above-mentioned reference values or mean values, the treatment stations whose measured values are already exhibiting a drift, approximations, or exceeding of at least one reference or target value or value range are not (any longer) taken into consideration. This type of evaluation has the advantage that with variable production conditions, such as, for example, temperature changes etc., the changes in the characteristic features are constantly or substantially constantly jointly taken into account, and therefore a process monitoring that is more independent of production conditions is made possible.

According to one possible exemplification, the reference signal is adjusted intermittently or continually or substantially continually. In one possible exemplification, the adjustment of the reference signal takes place by measurement signals from several treatment stations being detected at different points in time and being drawn on for the calculation of the reference signal. As a result, a “normal” time change of the measurement signals under different framework conditions caused, for example, by changes in load or temperature, different workpieces or workpiece fillings, can be integrated into the calculation of the reference signal, therefore leading to the reference signal adjusting to this change in framework conditions.

According to one possible exemplification, a set of reference signals is stored, wherein the set of reference signals comprises several reference signals dependent on a process parameter. The reference signal can therefore be adjusted by a process parameter being detected, for example by a sensor specific for this process parameter (temperature sensor, pressure sensor, etc.), and from the set of reference signals one or more reference signals are selected that correlate with the detected process parameters.

According to one possible exemplification, the reference signal is generated in-situ, in one possible exemplification by forming a mean value of the measurement signals or of signals derived from them, wherein the measurement signals or the signals derived from them are detected at least at two different treatment stations by sensors assigned to these treatment stations. In one possible exemplification, the measurement signals or the signals derived from them are detected staggered in time at least at two different treatment stations by the sensors assigned to these treatment stations. As a result, an adaptive adjustment of the reference signal can be carried out by taking account of measurement signals from different treatment stations.

According to one possible exemplification, the measurement signal or the signal that has been evaluated as having peculiarities in one possible exemplification to a treatment station of the transport element and/or to a workpiece. As a result, the workpiece can be subsequently checked, for example by an inspection unit, in order to determine whether this workpiece is exhibiting peculiarities that are indicative of errors, and therefore whether the process error identification was correct or not.

According to one possible exemplification, based on the measurement signal or based on the signal evaluated as having peculiarities that are indicative of errors, a trace can be made back to a part process at a treatment station. For example, the measurement signal form, the frequency spectrum, or the temporal characteristic of the measurement signal is analyzed, and, based on this, the process that was erroneous or exhibited peculiarities can be traced. As an alternative or in addition, the rotational position of the transport element or the locational position of a treatment station can be evaluated, in order to identify at which angle setting of the rotor or position of the treatment station the measurement signal indicative of errors or peculiarities was obtained.

According to one possible exemplification, the evaluation is carried out on the basis of several measurement signals provided by several sensors of a treatment station or on signals derived therefrom. Due to the distributed arrangement of several sensors at a treatment station (arranged, for example, at different functional elements), the identification of which part process has exhibited the error or peculiarity can be decidedly improved.

According to one possible exemplification, information items obtained within the framework of the evaluation of the measurement signals or signals derived therefrom are compared with information items from an inspection unit that subsequently examines the workpieces. It is therefore possible, by using the inspection unit, to check whether a workpiece that was detected by the evaluation unit as “erroneous” or with “peculiarities” also exhibits identifiable errors or peculiarities at the inspection process carried out by inspection unit.

According to one possible exemplification, by way of the comparison of information that is obtained within the framework of the evaluation of the measurement signals or signals derived from them with information from the inspection unit, comparison information is obtained, and, based on this comparison information, an adjustment of the reference signal is carried out. Accordingly, for example, in the event of the comparison information indicating that the evaluation of the measurement signals from the sensors provided at the treatment stations has detected an error or a peculiarity, but the inspection unit has not been able to identify any error or peculiarity, the reference signal can be adjusted to a higher tolerance threshold. The same of course also applies conversely, i.e. if the evaluation of the measurement signals from the sensors provided at the treatment stations has not detected any error or peculiarity, but the inspection unit has been able to identify an error or peculiarity, then the reference signal should be adjusted a lower tolerance threshold.

According to one possible exemplification, based on the evaluation of one or more measurement signals, or of a signal derived therefrom, process parameters for the transport element and/or a treatment station are adjusted, and/or maintenance and repair tasks are derived. For example, in the event of a sensor at a treatment station of a closing device receives a measurement signal that indicates a slippage of the closure unit in relation to the closure element, the drive torque of the drive unit is reduced. It is self-evident that in this case there are a large number of adjustment possibilities depending on the measurement signal detected.

According to one possible exemplification, the measurement signal is compared with a reference signal. The reference signal forms, for example, a “good” reference (i.e. it represents a reference signal which should be obtained with a process or process step operating free of any faults or without any peculiarities). The reference signal can be, for example, an amplitude and/or an amplitude characteristic, or also a frequency and/or frequency range of the measurement signal or a signal derived from it, and can be detected and stored after the machine is taken into operation or regularly at the start of production. By way of the comparison a technically simple identification of errors or peculiarities is possible.

According to one possible exemplification, a tolerance range is defined that forms a reference range for the measurement signal. In the event of the measurement signal leaving this reference range, it can be concluded that an untypical process or process step has occurred. The tolerance range can in one possible exemplification specify an amplitude range, frequency range, or a time amplitude characteristic range of the measurement signal or a signal derived from it.

The reference signal and the tolerance range may be formed from a correlation with one or more parameters of the device or components of the device. Such correlating parameters are, for example, the reference incremental value (i.e. the angular position of the main drive of the machine) the point in time or time frame in which a measurement signal, such as a frequency or sound is expected, depending on the nature or strength, a dependency of the measurement signal on the angular velocity of the rotor, etc.

The correlation could take place in the time range, and the amplitude and phase difference between the transition signals determined, wherein, for example, cross-correlation can be the correlation method.

According to one possible exemplification, the measurement signal is compared in the time range with a reference signal. As a result, the time characteristic of the measurement signal can be compared with the reference state (represented by the reference signal). In one possible exemplification, as a result of this, longer duration acoustic signals or several acoustic signals following one another in a temporal sequence (e.g. multiple impacts, rattling, etc.) can be effectively identified.

According to one possible exemplification, the measurement signal is transformed into the frequency range, and the measurement signal is compared in the frequency range with a reference signal. In the frequency range, periodically recurring acoustic signals in one possible exemplification can be better identified.

In addition to this, when monitoring of the transfer process it is also possible for the measurement signal or a signal derived therefrom to be detected simultaneously in the time range and in the frequency range. Accordingly, both the time behavior as well as the frequency behavior can be integrated into the assessment of the transfer process.

According to one possible exemplification, the measurement signal is filtered before the comparison with the reference signal. The filter can in one possible exemplification be a digital filter (e.g. FIR filter).

As a result of this, it is possible for interfering frequency ranges or specific background noises or interfering fundamental components to be filtered out and therefore not integrated into the measurement signal analysis.

According to one possible exemplification, the signal characteristic and/or the signal amplitude of the measurement signal or a signal derived therefrom to be evaluated. It is also possible for the spectral location of the measurement signal or a signal derived therefrom, (i.e. its frequency) to be evaluated. This likewise allows for conclusions to be drawn with regard to the causes of the peculiarity or irregularity.

According to a further aspect, the present application relates to a machine with a transport element with a plurality of treatment stations, wherein the treatment stations comprise in each case at least one assigned functional element in order to act directly or indirectly on the workpiece, wherein, by use of the treatment stations and/or their at least one functional element, in each case a workpiece that is to be treated can be conveyed during the treatment on a transport path between an inlet and an outlet, and/or the workpiece can be changed and/or produced or acted on while at least on a part piece of this transport path. The treatment stations comprise in each case, at least partially comprise at least one sensor for detecting an oscillation frequency and/or an acoustic signal, by which a pattern is detected, produced by the treatment process or production process at the respective treatment station and produced at this treatment station during the transport of the workpiece. An evaluation unit is also provided, which is configured to evaluate the measurement signal provided by the sensor or a signal derived from it, and to compare this with a reference signal.

As a result of this, errors or abnormalities in the process that is to be monitored can be identified at an early stage, and, as a result, damage to the machine can be effectively avoided and/or minimized and/or restricted, or maintenance of the machine initiated at an early stage. An adjustment of process parameters is also conceivable.

According to one possible exemplification, the sensor is provided such as to move with the rotor and arranged at the respective treatment station. As a result, a process that is carried out at the respective treatment station can possibly be detected by the sensor.

According to one possible exemplification, the sensor is formed by a contactless sensor that is aligned pointing towards a functional element, for the measurement of sound and/or vibration, in one possible exemplification by a directional microphone or a laser vibrometer. Such a directional microphone exhibits a directional effect (i.e. is configured such as to receive acoustic signals in one possible exemplification from a specific spatial direction or a specific spatial direction region, while conversely the reception from other spatial directions is attenuated or weakened).

According to one possible exemplification, a treatment station comprises two or more sensors, which are assigned to different regions of the treatment station. As a result, a spatially distributed detection of an oscillation frequency and/or an acoustic signal can be obtained.

According to one possible exemplification, the sensor (for example an acoustic sensor) is provided on a printed circuit board arranged inside the treatment station. As a result, a simple and economical implementation of the sensor in the treatment station can be achieved. As an alternative, it is conceivable for the sensor to be provided on a supporting component of the treatment station. As a result, the surface-borne sound inside the treatment station can be detected.

According to one possible exemplification, a filter is provided for filtering out interfering fundamental components and/or interfering background noises. As a result, interfering influences in the measurement of the acoustic signals can be substantially minimized.

According to one possible exemplification, the sensor is formed by a surface-borne noise sensor or a microphone. By use of a microphone, in one possible exemplification a directional microphone, it is possible, for example, for sound waves propagating in the air to be detected. Surface-borne sound sensors, conversely, allow for the measurement of sound waves which propagate in solid bodies, such as components of the treatment station or of the transport element.

According to one possible exemplification, the machine is configured in such a way that the reference signal is initially determined based on several measurement signals detected at different treatment stations. For example, a reference signal is calculated from measurement signals from different treatment stations, for example by a time averaging procedure. This time averaging procedure can be carried out with the use of weighting factors, such that the measurement signals can be weighted relative to one another. Accordingly, when determining the reference signal use can possibly be made of the fact that the processes of the same type that are carried out at the plurality of treatment stations lead in most cases to identical or very similar measurement signals at the sensors. This fact can be drawn on for the determination of the reference signal or the evaluation of measurement signals that are exhibiting peculiarities.

According to one possible exemplification, the machine is configured in such a way that the reference signal is adjusted intermittently or continuously. As a result, a temporal variation of the measurement signals, caused for example by changes in temperature or pressure, can be integrated into the calculation of the reference signal, and therefore lead to the reference signal being adjusted to this change.

According to one possible exemplification, a memory storage unit is provided for storing a set of reference signals, wherein the set of reference signals comprises a number of reference signals dependent on a process parameter. As a result, for example depending on process parameters (revolution speed of the rotor, filling material pressure, filling material temperature, bottle format, etc.), a reference signal is read out from this set of reference signals and used for the comparison.

According to one possible exemplification, the machine comprises an inspection unit, and the machine is configured in such a way that information items that are received within the framework of the evaluation of the measurement signals or signals derived therefrom are compared with information items from an inspection unit that examines the workpieces subsequently. For example, it is possible for a check to be made by the inspection unit as to whether a workpiece that was detected by the evaluation unit as “defective” or “with peculiarities” also exhibits errors or peculiarities that are identifiable in the inspection process carried out by the inspection unit. Accordingly, the process monitoring put into effect by use of the sensors can be checked by information from the downstream inspection unit.

According to one possible exemplification, the machine is configured in such a way that, by way of the comparison of information items obtained within the framework of the evaluation of the measurement signals or signals derived therefrom with information items from the inspection unit, comparison information items are obtained, and that, based on the comparison information, an adjustment of the reference signal is carried out. As a result, a correction of the process monitoring can be carried out based on information items from the inspection unit.

According to one possible exemplification, the machine is a container treatment machine, in one possible exemplification a filling machine, labeling machine, or a container closing device.

The expression “workpiece” in the meaning of the present application is understood to mean those units which can be treated at the treatment stations of a machine (i.e. one or more work processes can be carried out at the units) or can be produced (for example in a casting or pressing process, or some other production process). A workpiece can in one possible exemplification be a container.

The expression “container treatment machine” in the meaning of the present application is understood to mean such machines of a circulating design by which a container treatment can be carried out, such as printing, labeling, filling, closing machines etc.

The expression “defective” in the meaning of the present application is understood to mean when a machine component or a workpiece exhibits peculiarities or irregularities that lie outside a tolerable range.

The expression “container” in the meaning of the present application is understood to mean any type of container, in one possible exemplification bottles, cans, beakers, etc.

A transport element in the meaning of the present application is understood to mean a transport element that is driven such as to rotate about an axis of rotation in the form of a rotor, or, alternately, an enclosed transport path in the form of rails, in which transport elements can be moved, and at which the treatment stations are formed.

The expression “essentially” or “approximately” in the meaning of the present application signifies deviations in each case from the exact value by +/−10%, in one possible exemplification by +/−5%, and/or deviations in the form of changes which are not of significance for the function.

Further exemplifications and possible applications of the present application are also derived from the following description of possible exemplifications and from the figures. In this context, the features described and/or represented by illustrations are in principle the object of the present application, alone or in any desired combination, regardless of their combination in the claims or reference to them. The contents of the claims are also considered a constituent part of the description.

The above-discussed exemplifications of the present invention will be described further herein below. When the word “invention” or “exemplification of the invention” is used in this specification, the word “invention” or “exemplification of the invention” includes “inventions” or “exemplifications of the invention”, that is the plural of “invention” or “exemplification of the invention”. By stating “invention” or “exemplification of the invention”, the Applicant does not in any way admit that the present application does not include more than one patentably and non-obviously distinct invention, and maintains that this application may include more than one patentably and non-obviously distinct invention. The Applicant hereby asserts that the disclosure of this application may include more than one invention, and, in the event that there is more than one invention, that these inventions may be patentable and non-obvious one with respect to the other.

### BRIEF DESCRIPTION OF THE DRAWINGS

FIG. 1A shows schematically the main components of an example of a rotary container manufacturing arrangement for manufacturing containers;

FIG. 1 shows schematically an example of a rotary container handling machine with a plurality of container handling or treatment stations;

FIG. 2 shows by way of example and grossly schematically, the part processes carried out in a filling machine, in a view from above;

FIGS. 3, 4, and 5 show by way of example and schematically, three treatment stations of a filling machine for the representation of different part processes of a filling procedure;

FIG. 6 shows by way of example and schematically, a plurality of treatment stations of a filling machine for the representation of different part processes of a filling procedure, which are carried out during the rotational movement of the rotor; and

FIG. 7 shows by way of example and schematically, a plurality of treatment stations of a container closing device for the representation of different part processes of a closure procedure, which are carried out during the rotational movement of the rotor.

### DESCRIPTION OF EXEMPLIFICATION OR EXEMPLIFICATIONS

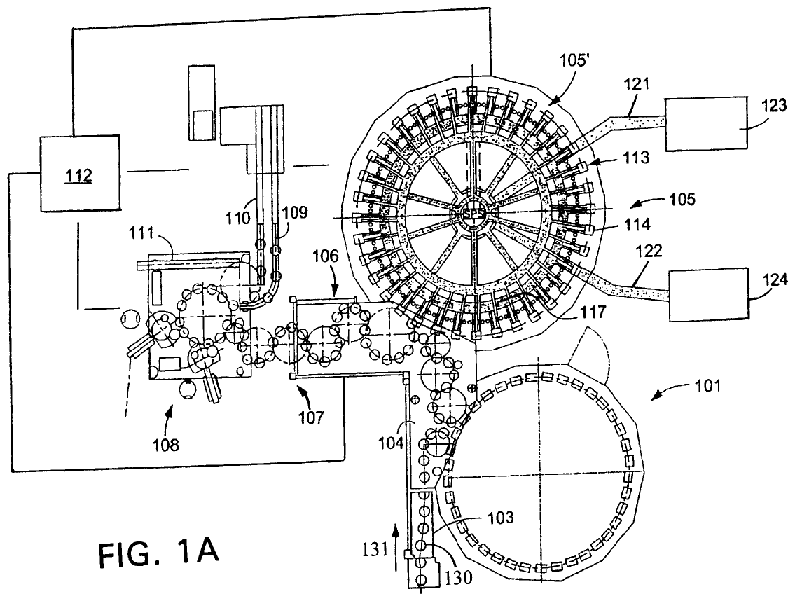

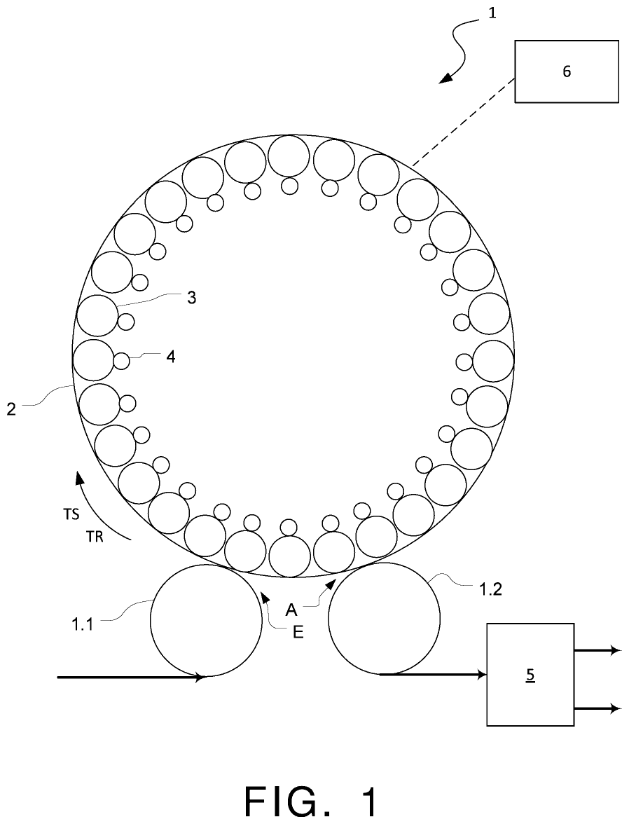

FIG. 1A shows schematically the main components of an example of a rotary container manufacturing arrangement for manufacturing containers 130, such as bottles or cans or other such containers. FIG. 1A shows a rinsing arrangement or rinsing station 101, to which the containers are fed in the direction of travel as indicated by the arrow 131, by a first conveyor arrangement 103, which can be a linear conveyor or a combination of a linear conveyor and a star wheel. Downstream of the rinsing arrangement or rinsing station 101, in the direction of travel as indicated by the arrow 131, the rinsed containers 130 are transported to a filling machine 105 by a second conveyor arrangement 104 that is formed, for example, by one or more star wheels that introduce containers 130 into the filling machine 105.

The filling machine 105 shown is of a revolving or rotary design, with a rotor 105′, which revolves around a central, vertical machine axis. The rotor 105′ is designed to receive and hold the containers 130 for filling at a plurality of filling positions 113 located about the periphery of the rotor 105′. At each of the filling positions 103 is located a filling arrangement 114 having at least one filling device, element, apparatus, or valve. The filling arrangements 114 are designed to introduce a predetermined volume of product into the interior of the containers 130 to a predetermined or desired level.

The filling arrangements 114 receive the product from a vessel 117. The vessel 117 is a component, for example, of the revolving rotor 105′. The vessel 117 can be connected by use of a rotary coupling or a coupling that permits rotation. The vessel 117 is also connected to at least one external supply by a conduit or supply line. In the embodiment shown in FIG. 1A, there are two external supplies 123 and 124 connected to the vessel 117 by corresponding supply lines, conduits, or arrangements 121 and 122.

Downstream of the filling machine 105, in the direction of travel of the containers 130, there can be a container closing arrangement or closing station 106 which closes or caps the containers 130. The container closing arrangement or closing station 106 can be connected by a third conveyor arrangement 107 to a container labeling arrangement or labeling station 108. The third conveyor arrangement may be formed, for example, by a plurality of star wheels, or may also include a linear conveyor device.

In the illustrated embodiment, the container information adding arrangement or station 108 has at least one unit, device, or module, such as for applying labels to containers 130. In the embodiment shown, the information adding arrangement 108 is connected by a star wheel conveyor structure to three output conveyor arrangements: a first output conveyor arrangement 109, a second output conveyor arrangement 110, and a third output conveyor arrangement 111, all of which convey filled, closed, and labeled containers 130 to different locations.

The first output conveyor arrangement 109, in the embodiment shown, is designed to convey containers 130 that are filled with a first product. The second output conveyor arrangement 110, in the embodiment shown, is designed to convey containers 130 that are filled with a second product. The third output conveyor arrangement 111, in the embodiment shown, is designed to convey incorrect containers 130. To further explain, the container filling plant includes at least one container inspection or monitoring device that is designed to inspect or monitor the containers 130. If a container is detected that has an undesired characteristic, such as defects, insufficient fill level, and incorrect information, the incorrect containers are directed to the third output conveyor arrangement 111 for removal.

The container filling plant can be controlled by a central control arrangement 112, which could be, for example, computerized control system that monitors and controls the operation of the various stations and mechanisms of the container filling plant.

The present application is described hereinafter in connection with a container treatment machine. It is understood that this exemplification is an example of the use of the method according to the present application, and an example for a type of machine. The present application can, however, be transferred in general to any desired machines for the treatment or production of workpieces or to methods for the monitoring of a process for treating or producing workpieces.

Represented in FIG. 1, with the general reference number 1, in grossly schematic form, is a machine for container treatment. The container treatment machine can be, for example, a machine for filling the containers with a fluid filling product, a closing device for applying closures onto a container opening, a labeling machine for applying a label, a container printing machine for applying a printed image onto the container wall, etc.

The machine 1 comprises a rotor 2, which is driven such as to rotate about a vertical machine axis. The drive can be continuous or intermittent (i.e. pulsed). Provided on the outer circumferential side of the rotor 2 are treatment stations 3, at which the treatment of the containers takes place. The treatment stations 3 are in one possible exemplification distributed at uniform angular distances on the circumferential side about the rotor 2.

The containers are conveyed to the machine 1, for example standing upright, by an inlet star 1.1 at an inlet E, and positioned at a treatment station 3. Due to the rotation of the rotor 2, the container arranged at the treatment station 3 is transported further in the transport direction TR to a transport path TS. During this further transport, the treatment process is carried out. The treatment process can be, for example, a filling process, a labeling process, a closure process of the container, etc. This treatment process can comprise, for example, several part processes or treatment process steps; with the filling process, for example, filling steps with different volume flows of the filling product.

By use of the rotation of the rotor 2, the container is transported to the outlet A, and from there it is transported away by an outlet star 1.2.

Provided at the treatment stations 1 are the sensors 4, by which acoustic signals or oscillations propagating in a body, designated hereinafter in general as oscillations, are detected. The sensors can be, for example, microphones, in one possible exemplification directional microphones or also surface-borne sound sensors. The surface-borne sound sensors can be provided in one possible exemplification for the measuring of oscillations in the treatment station 3 or its components or functional units.

The sensors 4 can be provided in this situation such as to be moved with the rotor 2. In one possible exemplification, in each case a sensor 4 or a group of sensors 4 can be integrated into a treatment station 3, in order to be able to detect oscillations that occur during the process. In this situation, the sensor 4 can be provided, for example, in the proximity of a component or functional unit of the treatment station 3, at which the oscillations occur that are to be detected. The sensor 4 can in one possible exemplification be provided and configured in such a way that monitoring of a process can be carried out during the rotation of the rotor 2 and the ongoing transport of the container associated with this. In one possible exemplification, this process may be started after the handover of the container at the treatment station 3, such that the transfer of the container at the treatment station 3 is detected by the process monitoring. As an alternative it is possible that the process monitoring relates to the detection of the taking up of the container by a gripping or clamping device of the treatment station 3 and the period of time after the container handover (i.e. to the process for container treatment that follows on from the container handover).

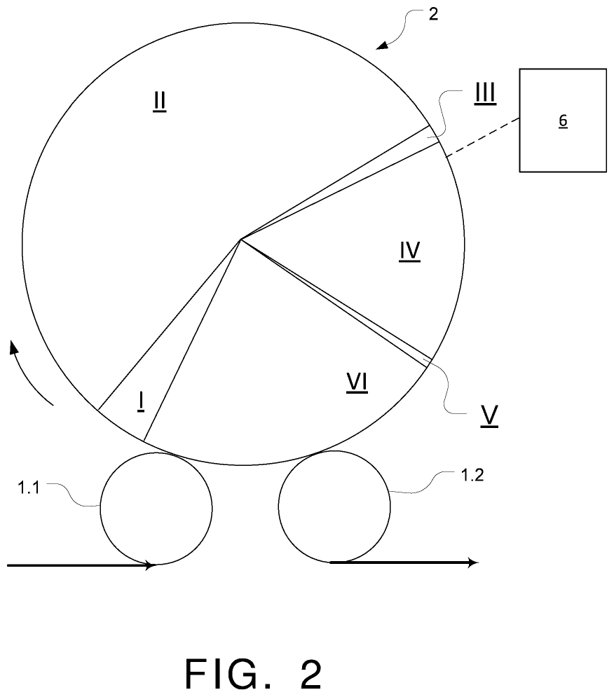

Before discussing further the specific operation of the sensors, the use of the sensors, according to at least one possible exemplification, will be discussed. FIGS. 2, 3, 4, and 5 show, by way of example, a filling machine, or treatment stations of a filling machine, and the use of the method according to the present application with such a machine.

Sketched in FIG. 2, by way of example, is the filling process, with its individual part processes in the angle regions of the rotor run at which these part processes are carried out.

After the container has been delivered by way of the inlet star 1.1, in a first angle sector I the opening of the filling valve takes place, as the first part process. This opening can, for example, be an opening from the closed position of the valve body into an open position, in which the filling valve is completely opened. Next, in a further part process, in the angle sector II, the container is partially filled with filling product. This filling can be carried out, for example, with the maximum possible filling product volume flow through the filling valve (rapid filling).

An angle sector III connects to the angle sector II, in which the filling valve is brought into a partially closed position, i.e. the valve body is moved out of the open position into an intermediate position between the open position and the closed position. As a result, the volume flow can be choked by the filling valve and the container filled with a reduced volume flow input (slow filling), which is completed in the angle sector IV.

In the angle sector V, the valve body is then moved out of the partially closed position into the closed position, such that, in the angle sector VI, the filling valve is closed (i.e. no more filling product can flow into the container). Following this, the container is conveyed away by way of the outlet star 1.2.

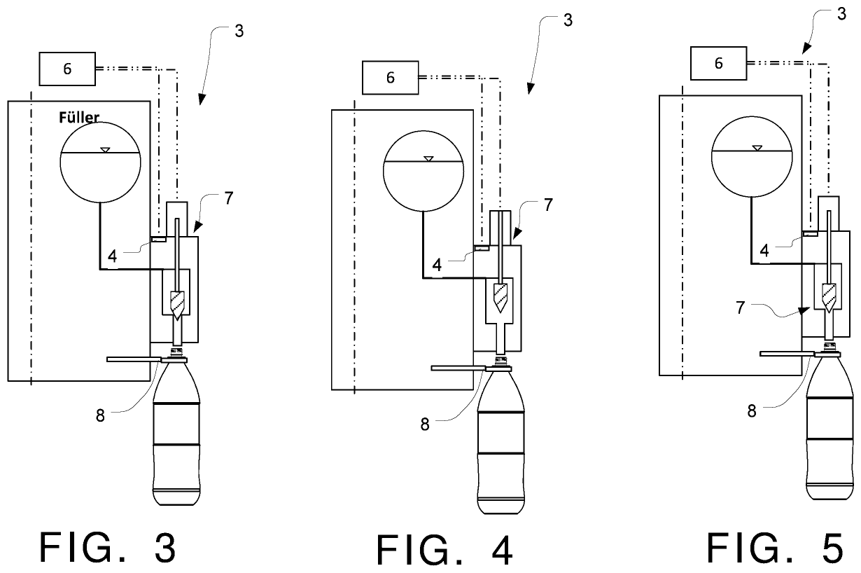

This filling process can be monitored by the evaluation unit 6, as is explained in greater detail hereinafter by reference to FIGS. 3, 4, and 5. FIG. 3 shows the closed position of the filling valve 7, and therefore corresponds to the state of the filling valve 7 immediately or substantially immediately or generally after the container inlet, or the state of the filling valve 7 in the angle sector VI. FIG. 4 shows the completely open position of the filling valve 7, and therefore corresponds to the state of the filling valve 7 in the angle sector II. FIG. 5 shows the partially closed position of the filling valve 7, and therefore corresponds to the state of the filling valve 7 in the angle sector IV.

As can be seen from FIGS. 3, 4, and 5, provided in each case at the filling valves 7, which are provided at the respective treatment stations 3, is in each case at least one sensor 4 for detecting oscillations in the region of this filling valve 7. This sensor 4 is coupled to the evaluation unit 6 for the transfer of information. This evaluation unit 6 can be formed, for example, by the machine control unit, such as a control computer. By use of the sensor 4, it is possible to detect and evaluate, for example, acoustic signals or oscillations which are caused by the raising or pressing of the valve body at the valve seat, by the beginning or ending of the fluid flow through the filling valve, by the movement of the valve body, or by the flowing of the filling product through the filling valve. In one possible exemplification, in the completely open position (FIG. 4) of the filling valve, the intensity of the flow sound is detected, in order to be able to draw conclusions from this with regard to the filling product volume flow flowing through the filling valve. In addition, in the partially closed position (FIG. 5), it can be detected whether the intensity of the flow sound has changed as expected, and no mechanical oscillations or acoustic signals could be detected which indicate contact of the valve body at the valve seat.

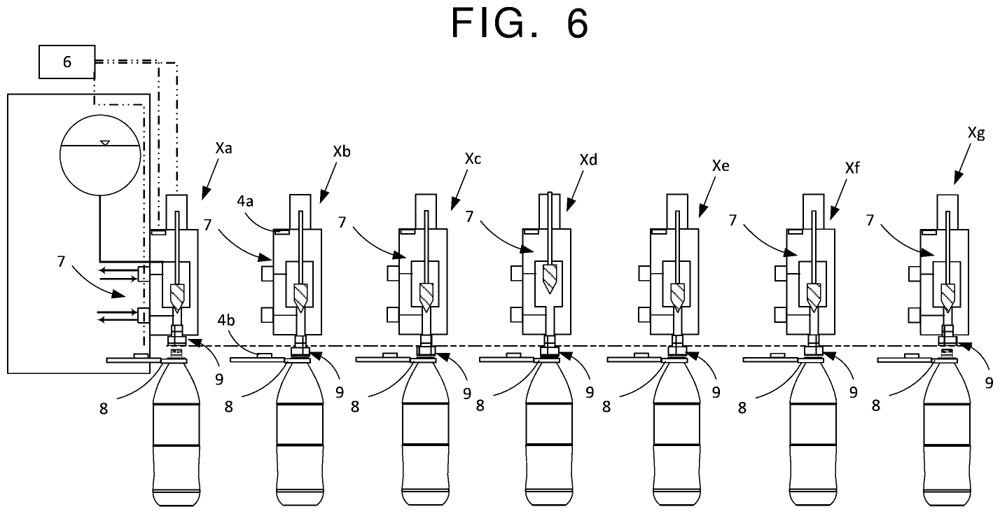

FIG. 6 shows in several partial representations Xa to Xg the part processes during a filling process in a greater degree of detail. The part processes shown in the partial representations Xa to Xg are run through in this sequence during the transport of the container from the inlet to the rotor 2. The treatment station 3, at which the respective filling element is provided, comprises in the possible exemplification shown a plurality of sensors 4. In the possible exemplification shown, these is a first sensor 4a, which is provided in the region of the filling valve 7, and a second sensor 4b, which is provided in the region of a container fixing element 8. This container fixing element 8 can be formed, for example, by a neck ring gripper, which can comprise actively movable gripper elements, but also passive gripper elements. These first and second sensors 4a, 4b, can detect oscillations at different parts of the filling element, as a result of which the precision of the evaluation and the identification of errors and peculiarities can be decidedly increased.

Hereinafter it is explained on the basis of the single partial representation in Xa to Xg, which part processes of the filling process can be detected by the first and second sensors 4a, 4b. In the partial representation Xa, the handover of the container takes place to the container fixing element 8, such that oscillations caused by this can be detected. The filling valve 7 is closed in this situation, and the container contact element 9 is located at a distance from the container mouth. Due to the rotation of the rotor 2, it is possible, for example, for wind sounds in the region of the container mouth to be detected.

As can be seen in the partial representation Xb, next the container contact element 9 is brought in contact against the container mouth, wherein the sounds caused by this are detected by the sensors 4a, 4b. In addition, a pre-tensioning of the container can be carried out here, which likewise causes detectable oscillations.

According to the partial representation Xc, it is further possible for a pre-tensioning of the container or a flushing or multiple flushing of the container to take place, wherein the sounds and oscillation behavior incurred can be detected.

As can be seen from the partial representation Xd, there then follows the complete opening of the filling valve 7, wherein, for example, here it is the adjustment movement of the valve body, the flow sound of the filling product, and the flow back of the tensioning gas which can be detected.

Next, as shown in the partial representation Xe, the filling valve is closed (complete closure or partial closure), wherein, in turn, it is the adjustment movement of the valve body and the end or fading away of the flow sound or the fading away of the back-flowing tensioning gas which can be detected.

According to the partial representation Xf, this can then be followed by the release of the container, wherein the sound incurred by the release and possible subsequent dripping sounds can be detected by the sensors 4a, 4b.

According to the partial representation Xg, next the container contact element 9 is located at a distance from the container mouth. In this situation, the sounds are detected which are incurred by the movement of the container contact element 9 or the container fixing element 8, and when the container is removed from the container fixing element 8. It is likewise possible, after the movement of the container contact element 9 or the container fixing element 8, due to the rotation of the rotor 2, for a wind sound to be identified in the region of the container mouth.

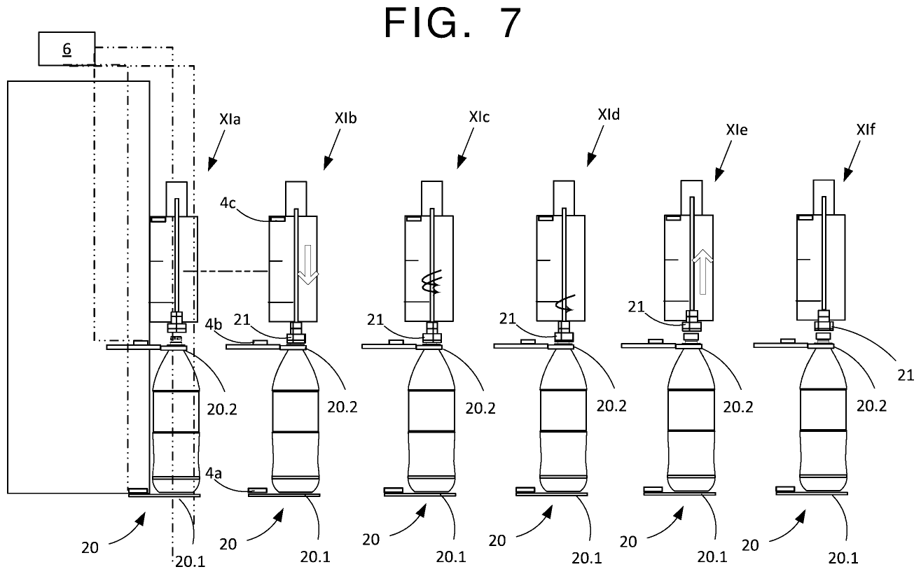

FIG. 7 shows, by way of example, a closer or treatment stations 3 of a closer, and the application of the method according to the present application with such a machine.

The treatment stations 3 of a closer, which are likewise provided at a rotor which can be driven such as to circulate, comprise in an inherently known manner a container fixing device 20, by which the containers which are to be closed are held or fixed at the treatment station 3. The container fixing device 20 in the possible exemplification shown is formed by a container carrier 20.1, on which the containers stand upright on their container bases, and a container holder 20.2, which engages in the region of the container neck or the container mouth, such as a neck ring gripper. In addition, a closure mechanism is provided, by which a closure element is applied onto the container mouth. The closure mechanism can in one possible exemplification comprise a closure unit 21, which can be driven such as to rotate about a vertical axis, also designated as a tulip, by which a closure element (e.g. a screw closure cap) can be screwed onto the thread provided at the container mouth. As an alternative, the closure mechanism can be configured for the clamping securing of a closure element (e.g. crown corks).

FIG. 7 shows in several partial representations XIa to XIf several part processes of a closure process. The part processes shown in the partial representations XIa to XIf are, for example, run through in this sequence during the transport of the container from the inlet to the outlet of the rotor 2. The treatment station 3, at which the respective closure element is provided, comprises, in the possible exemplification shown, a plurality of sensors 4. In the possible exemplification shown, these are a first sensor 4a, which is provided in the region of the container carrier 20.1, a second sensor 4b, which is provided in the region of the container holder 20.2, and a third sensor 4c, which is provided in the region of the closure unit 21 or its drive. It is understood that more than the sensors referred to can be provided distributed at different positions at the processing station 3. By use of these first to third sensors 4a, 4b, 4c, oscillations can be detected at different locations of the treatment station 3, as a result of which the precision of the evaluation and identification of errors or peculiarities can be decisively increased.

It will be explained hereinafter, on the basis of the individual partial representation in XIa to XIf, which part processes of the closure process can be detected by the sensors 4a, 4b, and 4c. In the part process according to the partial representation XIa, first the container is conveyed to the handling station and the closure element is received in the closure unit 21. In this situation, for example, sounds and oscillations caused by the container being delivered, or by the placement of the closure element, are detected by the sensors 4a, 4b, and 4c. Likewise, wind sounds caused by the rotating treatment station 2, such as wind sounds at the open container mouth of the filled container, are also detected.

In the part process shown in the partial representation XIb, the closure unit 21 is lowered, as indicated by the arrow, such that the closure element received in the closure unit 21, comes in contact against the container mouth. In this situation, for example sounds or oscillations caused by the lowering of the closure unit 21 can be detected by the sensors 4a, 4b, and 4c.

In the part process according to the partial representation XIc, the closure unit 21 is set in rotation in order to screw the closure element onto the thread. This screwing process can take place in several steps. For example, in a first step the closure element is screwed on with a higher revolution speed, and in a subsequent second step at a lower revolution speed. In the process step shown in the partial representation XIc, this is, for example, a screwing process with a higher revolution speed (in comparison with the process step according to the partial representation XId), as is indicated by the curved double arrow. As a result, the closure element can be screwed on rapidly, until the upper, inner closure element surface comes in contact at the container mouth. In this situation, for example, the sounds and oscillations caused by rotation of the closure unit 21, the drive of this closure unit 21, or the rubbing of the closure element at the thread, can be detected by the sensors 4a, 4b, and 4c.

In the part process according to the partial representation XId, a rotation of the closure unit 21 then takes place at reduced revolution speed (in comparison with the process step according to the partial representation XIc), as a result of which the closure element is tightened on the container thread. In this situation, for example, sounds and oscillations caused by the rotation of the closure unit 21, the drive of this closure unit 21, the rubbing of the closure element on the thread, or by the rubbing of the closure unit 21 against the closure element, are detected by the sensors 4a, 4b, and 4c.

This is followed by the raising of the closure unit 21, as shown in the partial representation XIe. In this situation, the sounds and oscillations caused by the movement of the closure unit 21 are detected by the sensors 4a, 4b, and 4c.

After the raising of the closure unit 21, for example, wind sounds from the closed container due to the further rotation of the rotor 2, or sounds caused by the releasing of the container from the treatment station 2 can be detected (partial representation XIf).

Due to the distribution of several sensors at different positions in the treatment station 2, the sounds and oscillations which occur at different locations can be better detected and assigned more precisely or substantially more precisely to the respective functional elements of the treatment station 2.

In at least one possible exemplification, with this method and the method variants referred to, reference signals and the measurement signals relating to them in each case are detected by the respective sensor of the treatment stations all or some at the same location or in the same angle region of the device. Accordingly, in at least one possible exemplification, the reference signals are detected from the patterns from different treatment stations or their function elements, which are also detected at different time spans (i.e. staggered times).

As has already been indicated heretofore, and is common to the at least one possible exemplification, due to the same or essentially the same process steps being carried out at the respective treatment stations 3, it can be assumed that processing stations 3 which do not exhibit any errors or peculiarities will deliver the same or essentially the same measurement signals to the respective sensors. As a result, an adjustment can be made of the measurement signals from the different treatment stations 3, and errors or peculiarities can be identified in that the measurement signals from one treatment station show significant deviations in relation to the measurement signals from the other treatment stations 3. In one possible exemplification, an averaging of the measurement signals from the treatment stations 3 can be carried out, and, for the evaluation of a current measurement signal, a comparison made between this current measurement signal and the mean value of measurements signals received previously. In this situation, with this mean value formation, in one possible exemplification, the measurement signals can be excluded which show features indicative of errors or peculiarities.

It is likewise conceivable that all or substantially all or some the sensors of a treatment station 3 can be adjusted relative to one another by a comparison of their measurement signals.

The design and function of the sensors 4 will now be discussed in greater detail in accordance with one possible exemplification. The sensor 4 can be configured in one possible exemplification for detecting measurement signals in the time range. In one possible exemplification, the sensor 4 can provide a time-changeable electrical output signal, which is dependent on the oscillations detected by the sensor 4. The output signals provided by the sensor 4 can be analyzed in an evaluation unit 6, either directly or after further signal processing, in order to determine whether the process that is to be monitored is running within predetermined tolerance values, or whether the detected signals exhibit peculiarities that are indicative of an error or signs of wear, and therefore proactive maintenance or repair are necessary and/or desired or process parameters must or should be changed, for example travel paths of a functional unit.

A shown in FIG. 1, the evaluation unit 6 can be provided as a central evaluation unit (i.e. the sensors 4 are coupled to the evaluation unit 6 by use of the data line) represented by a dotted line (represented by way of example), and this unit carries out the analysis and evaluation of the signals provided by the sensors 4. As an alternative, it is also conceivable that the evaluation is carried out by a plurality of evaluation modules, and in each case groups of sensors 4 are formed, wherein each group of sensors 4 is coupled to a specific evaluation module. With such an arrangement it is also possible for a superordinated evaluation unit to be provided, to which the evaluation information provided by the evaluation modules is conveyed, and evaluated for the entire machine. In one possible exemplification, the arrangement of evaluation modules and a superordinated evaluation unit can form a master-slave structure for the evaluation of the signals.

In operation, a plurality of signal spectra (signal amplitude over the frequency), can be obtained, for example, by a transformation of the time-dependent signals provided by a sensor 4 into the frequency range. The transformation can take place, for example, by use of a Fast-Fourier Transformation (FFT).

For example, at a first frequency, a dominating spectrum portion results, for example, from a periodic and time-discrete occurring process step (e.g. closure movement of valve, delivery of closure element, etc.). The first frequency can in this situation, for example, be dependent on the revolution speed of the rotor 2. Ancillary spectrum portions outside of the dominant spectrum portion represent, for example, interfering spectrum portions, which result from procedures at the container treatment machine 1 that produce other acoustic signals.

By way of example, a tolerance window can be established, in which a frequency range and an amplitude range are defined for the dominating spectral portion. In the situation in which the frequency and amplitude of the dominating spectral portion is located inside the tolerance window, the process step is recognized as “error-free” or an “without peculiarities” (i.e. no information indicative of a fault is being generated by the evaluation unit 6), or a proposal for a change of a process parameter (reduction of valve lift, change in closure speed of the valve, etc.). In the situation in which the amplitude of the spectrum portion resulting from the transfer of the holding and centering unit 2 falling short or exceeding the amplitude range specified by the tolerance window, and/or the frequency of this spectral portion lying outside the frequency range determined by the tolerance window, this is recognized as “errored” or “with peculiarity”, and therefore information indicative of a fault is generated, or the changing of a process parameter is proposed. It is also conceivable that several tolerance windows are used, for example a first tolerance window in the range of a frequency that corresponds to the revolution speed of the rotor, and a second tolerance window in the range of a frequency that corresponds to the frequency of the periodically recurring process step that to be detected.

In other words, each process step or mechanical function generates an acoustic signal having characteristics, such as an amplitude (Hertz), frequency, and decibel level, which acoustic signal will be detectable as being the dominant or most noticeable acoustic signal outside of the other, ancillary, acoustic signals produced, such as other mechanical sounds not pertinent to the particular process step. For example, the dominant acoustic signal might be produced by the closing of a filling valve, while there may be acoustic signals in the background produced by other mechanical operations or functions that are not to be analyzed. When the process step or mechanical function is performed as intended, an acoustic signal will be produced having the desired characteristics, such as, for example, a certain amplitude, frequency, and decibel level. The monitoring system uses this acoustic signal as a model of sorts for comparison. A deviation from this acoustic signal may indicate a malfunction or improper operation of the corresponding device. In the case of a filling valve, it could indicate incorrect timing of the closure or too hard of a closure or similar. It should be understood that some deviation from the ideal acoustic signal is acceptable, so a tolerance window can be established to determine acceptable deviations from the individual characteristics, such as the amplitude, frequency, and decibel level. In other words, ranges for the different characteristics of the acoustic signal for a particular process or function can be set, such that not all deviations from the ideal acoustic signal are detected as being errors or malfunctions. The tolerance window or ranges can be set as desired to establish what level of deviation, such as high, medium, or low, for example, constitutes an undesired condition or error condition indicating a malfunction.

The evaluation unit 6 can be configured such as to specify or localize more precisely the reason for the error or the peculiarity. In one possible exemplification, the evaluation unit 6 can identify at which treatment station 3 the error or peculiarity has been shown. In addition, the evaluation unit 6 can be configured to detect which part process or process step of the process being carried out at the treatment station 3 has incurred the error or peculiarity. This can be done, for example, by analysis of the measurement signal from the sensor 4, for example in such a way that the frequency or frequency spectrum and/or the time characteristic of the measurement signal is evaluated, and therefore identifies a specific part process or process step. In addition or as an alternative, for example, part process or process step exhibiting the peculiarity or the fault can be identified by evaluating the time span between the handover of the container to the treatment station and the occurrence of the oscillation. As an alterative, the rotation angle can be detected, by which the treatment station 3 has been moved further by the rotor 2 since the handover of the container to this treatment station 3 (other reference points of time are possible). From this rotation angle it is likewise possible to identify the part process or process step exhibiting the peculiarity or error.

In addition or as an alternative it is possible for the measurement signals from several sensors 4 of the treatment station 3, which are arranged at different positions inside the treatment station 3, to be evaluated for the determination of the part process or the process step that has incurred the error or the peculiarity. By use of the different positions of the sensors 4 and the occurrence of oscillations at different positions in the respective treatment station 3, a localization can be carried out of the place of occurrence of the oscillations.

The evaluation unit 6 can be further configured so as to assign the peculiarity or error identified to a container that was being treated at the respective treatment station 3 at which the peculiarity is being shown. In this way, a peculiarity detected at a treatment station 3 can lead to a peculiarity at a container being treated at this treatment station 3, such as an inadequate filling level, erroneous labeling, or a defective closure. This peculiarity of the container can, as shown in FIG. 1, be identified in an inspection unit 5 that follows on from the outlet A in the transport direction TR. In one possible exemplification, the container information items detected in the inspection unit 5 are compared with the evaluation information items provided by the evaluation unit 6. In this situation it is possible, in one possible exemplification, for containers that have been identified by the evaluation unit 6 as defective or as exhibiting a peculiarity to be examined by the inspection unit 5, and specifically or generally so as to determine whether the inspection unit 5 also identifies an error or peculiarity involving the container. The inspection unit 5 can accordingly check, for example, the filling level in the container, the labeling, the closure, etc. Accordingly, the result from the evaluation unit 6 can be verified or corrected by the inspection unit 5. In the event that the inspection unit 5, unlike the evaluation unit 6, does not identify an error or peculiarity, it is then possible, if necessary and/or desired, for a reference signal for the decision taken in the evaluation unit 6 to be adjusted. In general, therefore, a dynamic adjustment can be carried out of the decision criteria adopted for the decision in respect of an error or a peculiarity in the evaluation unit 6, based on the information items detected by the inspection unit 5.

At the treatment stations 3 of the machine 1, in each case in one possible exemplification the same or essentially the same treatment process or production process is carried out. Accordingly, at the treatment stations 3, provided no errors or peculiarities occur in the process being carried out there, the sensors 4 of the respective treatment stations 3 will deliver identical or very similar measurement signals. For the identification of errors or peculiarities, the evaluation unit 6 can compare the measurement signals assigned to the respective treatment stations 3 with one another, and detect errors or peculiarities in that the measurement signals from one treatment station 3 show a significant deviation in relation to the measurement signals detected at the other treatment stations 3. In general, therefore, the detection of an error or a peculiarity can take place by comparison with one another of the measurement signals obtained at the respective treatment stations 3.

In at least one possible exemplification according to the present application, a reference signal that is drawn on for the purpose of evaluation is derived by averaging of the measurement signals provided by the sensors 4 of the treatment stations 3. This reference signal can, for example, be determined in advance, and deposited in a memory storage unit, such that, in the subsequent operation of the machine 1, the current measurement signals can be compared with the reference signal. In one possible exemplification, the reference signal is adjusted during the running of the machine continuously or intermittently, for example after specific time intervals, in order to be able to adjust the reference signal dynamically to the current circumstances. For example, the oscillations detected by the sensors 4 at the treatment stations 3 can exhibit a dependency on process parameters. For example, the oscillations may exhibit a temperature dependency, or may change with a variable process value (e.g. volume flow of the filling product). By the dynamic adjustment of the reference signal, this reference signal can be adjusted to these current process circumstances.

It is also possible for the reference signal to be dynamically adjusted on the basis of a measurement value of a sensor that is detecting a process parameter. For example, a temperature sensor can be provided in order to detect the ambient temperature, filling product temperature, etc., or a pressure sensor for detecting the pressure of the filling product, or, in general, a sensor for detecting a process parameter. Based on the information from the sensor that is detecting the process parameter, the reference signal can be adjusted. For example, it is also possible for a table of reference signals to be stored, which contains several reference signals or reference signal values that are dependent on the process parameter. The selection of the reference signal or reference signal value to be used can be made as a dependency of the process parameter detected.

According to one possible exemplification, an evaluation of a signal received from the sensor 5, or a signal derived therefrom, in the frequency range, can be performed. In this situation, a measurement signal obtained from the sensor 4 in the frequency range, and a reference signal, likewise in the frequency range, are delivered to a comparator. The reference signal can, for example, be a frequency spectrum of an acoustic signal, which occurs during the process run at the treatment station 3. This reference signal can, for example, be determined and stored when the container treatment machine 1 is taken into operation. The measurement signal and/or the reference signal can be unfiltered signals, or can be filtered by use of a suitable filter (e.g. bandpass filter). Next, the measurement signal is compared by the comparator with the reference signal. The comparator can in one possible exemplification be configured in such a way that any deviations between the measurement signal and the reference signal will be detected. In the event of an adequate concordance between the measurement signal and the reference signal, an error-free process run, or process run without peculiarities will be identified. Otherwise, an error message can be generated. The comparator can be a constituent part of a central evaluation unit, or can be provided decentralized in the region of the respective sensors. For example, in the respective treatment station 3, next to the sensor 4, an evaluation module (comprising, among other elements, the comparator) can also be provided, in which, for example, the reference signal is stored, or which has access to a memory storage unit, in which the reference signal is deposited. It is also possible, for example, for the comparison of the measurement signal with the reference signal to take place in this evaluation module. This evaluation module can then communicate with a superordinated evaluation unit 6.

In another possible exemplification, an evaluation of a signal provided by a sensor 4, or a signal derived from that, in the time range, can also be performed. As input signals, a measurement signal and a reference signal are provided in the time range. The reference signal can be, for example, a measured time characteristic of an acoustic signal, which occurs during the process run at the treatment station 3. This reference signal can, for example, be determined and stored when the container treatment machine 1 is taken into operation. Next, the measurement signal provided by a sensor 4 and the reference signal are filtered by use of a filter, in one possible exemplification a band filter. By use of this it is possible, for example, for interfering fundamental components or background noises to be filtered out. The filtered measurement signal and the filtered reference signal are then passed to the comparator. The comparator can in one possible exemplification be configured in such a way that any deviations between the filtered measurement signal and the filtered reference signal will be detected. In the event of an adequate concordance between the measurement signal and the reference signal, an error-free process run, or process run without peculiarities will be identified. Otherwise, an error message can be generated. The comparator can be a constituent part of a central evaluation unit, or can be provided decentralized in the region of the respective sensors. For example, in the respective treatment station 3, next to the sensor 4, an evaluation module (comprising, among other elements, the comparator) can also be provided, in which, for example, the reference signal is stored, and in which the comparison of the filtered measurement signal with the filtered reference signal takes place. This evaluation module can then communicate with a superordinated evaluation unit 6.

It is also conceivable for the measurement signal to be analyzed in time range as well as in the frequency range, and in each case to be subjected to a comparison with a reference signal or a check against a tolerance window.

As sensors, use is made, for example, of microphones, in one possible exemplification directional microphones, or also surface-borne sound sensors. These can in one possible exemplification be configured as screened against other sources of sounds.

In another possible exemplification, there is a method in which the reference value in the tolerance field correlates with the angular position of the rotor 2 or, respectively, the container stations 3 arranged at it. The angular position is the position of a portion of the rotor 2, such as the portion at which a container is held, on the circular path of movement or rotation of the rotor, as measured according to a 360 degree circle. For example, the point at which a container is transferred or handed over to the rotor 2 could be set as the zero degree position. This portion of the rotor 2 then must travel a full 360 degrees to return to the zero degree position. The angular position is therefore the location of this portion of the rotor 2 at a particular time and place along the path of rotation. For example, the 180 degree position would be the time or place at which the portion of the rotor 2 is located halfway along the circular path of movement. If a process step is to occur at the 180 degree position, the angular position can be used in conjunction with the acoustic monitoring to determine errors and faulty operation. This is possible, for example, during the conveying of a container from the inlet star 1.1 to the respective treatment station. In this situation, the point in time of the transfer of the container is known by way of the angle position, such that it is possible to record the signals at that point in time, as a result of which data quantities and times can be economized. The measurement signals at this point in time or at this location should then correlate with one another.

In addition to the signal strength, a signal bundling in the time tolerance window is also expected before and after the first point in time, which correlates with an angular position a of the respective treatment station 3, for example of the rotor 2. In this situation a certain time scatter or spread in the tolerance window is expected. For example, measurement values relating to handover procedures of the containers can be recorded at the transfer from the inlet star 1.1 to the treatment stations 3. In the event the inlet star 1.1 is not synchronized in operation with the rotor 2, measurement signals from transfer procedures which are caused by an inlet star 1.1 will be detected that are outside of the tolerance window and therefore could be considered to be “not synchronous” signals that show an erroneous operation condition. In the event the inlet star 1.1 is synchronized in operation with the rotor 2, measurement signals from transfer procedures which are caused by an inlet star 1.1 will be detected that are within the tolerance window and therefore could be considered to be “synchronous” signals that show a proper or acceptable or desired operation condition.

For example, if there is a large and impermissible time spread of the detected signals, this is evidence that the rotor 2 and the inlet star 1.1 must or should be adjusted with regard to synchronous running. In this situation it may be presumed that the measurement signals scattered above and below the permissible tolerance window are a consequence of the deficient synchronous running, and that there is not, in fact, a defect at the treatment stations themselves.

The present application has been described heretofore by way of possible exemplifications. It is understood that a large number of modifications or derivations are possible without thereby departing from the underlying possible concept of the present application.

One feature or aspect of an exemplification is believed at the time of the filing of this patent application to possibly reside broadly in a method for monitoring a process or process step on a machine 1 with a transport element 2 having a plurality of treatment stations 3, wherein each of the treatment stations 3 comprise a functional element, by which action is exerted directly or indirectly onto the workpiece, wherein, by use of the treatment stations 3 and/or their at least one functional element, in each case a workpiece that is to be treated is conveyed during the treatment on a transport path TS between an inlet E and an outlet A, or the workpiece is modified and/or produced at a treatment station 3 at least on one part piece of the transport path TS, or action is exerted on this workpiece, wherein at least partially the treatment stations 3 comprise in each case at least one sensor 4 for detecting an oscillation frequency and/or an acoustic signal, by which a pattern is detected, produced by the treatment or production process at the respective treatment station 3 and during the transport of the workpiece at this treatment station 3, and that the measurement signal provided by the sensor 4 or a signal derived therefrom is evaluated, and compared with a reference signal.

Another feature or aspect of an exemplification is believed at the time of the filing of this patent application to possibly reside broadly in the method, wherein the pattern is derived from one or more functional elements provided at the treatment station 3 and not released from the treatment station 3 during the entire process.

Yet another feature or aspect of an exemplification is believed at the time of the filing of this patent application to possibly reside broadly in the method, wherein the pattern is derived at least due to a location change of a functional element or a part thereof.

Still another feature or aspect of an exemplification is believed at the time of the filing of this patent application to possibly reside broadly in the method, wherein the pattern comprises an oscillation frequency and/or an acoustic signal, which is derived from the attaining of an at least temporary end position of the functional element of a part thereof.

A further feature or aspect of an exemplification is believed at the time of the filing of this patent application to possibly reside broadly in the method, wherein the pattern comprises an oscillation frequency and/or an acoustic signal, which derives from the spatial location change of the function element or a part thereof.

Another feature or aspect of an exemplification is believed at the time of the filing of this patent application to possibly reside broadly in the method, wherein the process comprises several part processes, wherein the patterns derived from these part processes are detected by one single sensor 4 or by a group of several sensors 4 provided at the respective treatment station 3.

Yet another feature or aspect of an exemplification is believed at the time of the filing of this patent application to possibly reside broadly in the method, wherein at the different treatment stations in each case the same process steps or the same part processes are carried out in specific regions of the transport path between the inlet and the outlet, and/or that at different treatment stations between the inlet and the outlet the same process steps or same part processes are carried out staggered in time in relation to one another.

Still another feature or aspect of an exemplification is believed at the time of the filing of this patent application to possibly reside broadly in the method, wherein measurement signals are detected simultaneously at two or more treatment stations 3.

A further feature or aspect of an exemplification is believed at the time of the filing of this patent application to possibly reside broadly in the method, wherein the reference signal is initially detected on the basis of several measurement signals detected at different treatment stations 3.

Another feature or aspect of an exemplification is believed at the time of the filing of this patent application to possibly reside broadly in the method, wherein the reference signal is detected staggered in time in relation to the measurement signals detected at the different treatment stations 3.

Yet another feature or aspect of an exemplification is believed at the time of the filing of this patent application to possibly reside broadly in the method, wherein the reference signal is detected and/or adjusted intermittently or continuously.

Still another feature or aspect of an exemplification is believed at the time of the filing of this patent application to possibly reside broadly in the method, wherein a set of reference signals are stored in a memory, wherein the set of reference signals comprises several reference signals that are dependent on a process parameter.

A further feature or aspect of an exemplification is believed at the time of the filing of this patent application to possibly reside broadly in the method, wherein the reference signal is generated in-situ, in one possible exemplification by a mean value formation of the measurement signals or signals derived from them, wherein the measurement signals or the signals derived from them are detected at least at two different treatment stations 3 by the sensors 4 assigned to these treatment stations 3.

One feature or aspect of an exemplification is believed at the time of the filing of this patent application to possibly reside broadly in the method, wherein the measurement signal or the signal being evaluated with regard to peculiarities indicative of errors is assigned to an angle segment, in one possible exemplification to a treatment station 3 of the rotor 2 and/or to a workpiece.

Another feature or aspect of an exemplification is believed at the time of the filing of this patent application to possibly reside broadly in the method, wherein, based on the measurement signal or based on the signal being evaluated with regard to peculiarities indicative of errors is attributed to a part process at a treatment station 3.

Yet another feature or aspect of an exemplification is believed at the time of the filing of this patent application to possibly reside broadly in the method, wherein the evaluation is carried out on the basis of measurement signals or signals derived therefrom which are provide by several sensors 4 of a treatment station 3.

Still another feature or aspect of an exemplification is believed at the time of the filing of this patent application to possibly reside broadly in the method, wherein information items received within the framework of the evaluation of the measurement signals or signals derived from them are compared with information items from an inspection unit 5 examining the workpieces downstream.

A further feature or aspect of an exemplification is believed at the time of the filing of this patent application to possibly reside broadly in the method, wherein, by way of the comparison of the information items received within the framework of the evaluation of the measurement signals or signals derived therefrom with information items from the inspection unit 5, comparison information items are obtained, and that, based on the comparison information items, an adjustment of the reference signal is carried out.

Another feature or aspect of an exemplification is believed at the time of the filing of this patent application to possibly reside broadly in the method, wherein, based on the evaluation of one or more measurement signals or of a signal derived therefrom, process parameters for the transport element 2 and/or a treatment station 3 are adjusted, and/or maintenance and repair tasks are derived.

Yet another feature or aspect of an exemplification is believed at the time of the filing of this patent application to possibly reside broadly in the method, wherein reference signals and measurement signals to be compared with these reference signals are detected by the respective sensor 4 of the treatment stations 3 in the same transport path section.

One feature or aspect of an exemplification is believed at the time of the filing of this patent application to possibly reside broadly in a machine with a transport element 2 with a plurality of treatment stations 3, wherein each of the treatment stations 3 comprise at least one associated functional element, in order to exert action on the workpiece directly or indirectly, wherein, by use of the treatment stations and/or their at least one functional element, in each case a workpiece that is to be treated can be conveyed during the treatment on a transport path TS between an inlet E and an outlet A, and/or the workpiece can be changed and/or produced at least on a part piece of this transport path TS or action can be exerted on it, wherein at least partially the treatment stations 3 comprise in each case at least one sensor 4 for detecting an oscillation frequency and/or an acoustic signal, by which a pattern is detected that is produced by the treatment or production process at the respective treatment station 3 and during the transport of the workpiece at this treatment station 3, and that an evaluation unit 5 is provided, which is configured to evaluate the measurement signal provided from the sensor 4 or a signal derived therefrom, and to compare it with a reference signal.

Another feature or aspect of an exemplification is believed at the time of the filing of this patent application to possibly reside broadly in the machine, wherein the sensor 4 is provided such as to be moved with the rotor 2, and is arranged at the respective treatment station 3.

Yet another feature or aspect of an exemplification is believed at the time of the filing of this patent application to possibly reside broadly in the machine, wherein the sensor 4 is formed by at least one contactless sensor in one possible exemplification a directional microphone or a laser vibrometer, aligned onto a functional element for the measurement of sound and/or vibration.

Still another feature or aspect of an exemplification is believed at the time of the filing of this patent application to possibly reside broadly in the machine, wherein a treatment station 3 comprises two or more sensors 4, which are assigned to different regions of the treatment station 3.

A further feature or aspect of an exemplification is believed at the time of the filing of this patent application to possibly reside broadly in the machine, wherein a digital or a physical filter is provided for filtering out interfering fundamental components and/or interfering background sounds.

Another feature or aspect of an exemplification is believed at the time of the filing of this patent application to possibly reside broadly in the machine, characterized in that the sensor 4 is formed by a surface-borne sound sensor or a microphone.

Yet another feature or aspect of an exemplification is believed at the time of the filing of this patent application to possibly reside broadly in the machine, wherein the machine is configured in such a way that the reference signal which is initially based on several measurement signals detected at different treatment stations 3 is detected.

Still another feature or aspect of an exemplification is believed at the time of the filing of this patent application to possibly reside broadly in the machine, wherein the machine is configured in such a way that the reference signal is adjusted intermittently or continually.

A further feature or aspect of an exemplification is believed at the time of the filing of this patent application to possibly reside broadly in the machine, wherein a memory storage unit is provided for storing a set of reference signals, wherein the set of reference signals comprises several reference signals that are dependent on a process parameter.

Another feature or aspect of an exemplification is believed at the time of the filing of this patent application to possibly reside broadly in the machine, wherein the machine comprises an inspection unit 5, and that the machine is configured in such a way that information items obtained within the framework of the evaluation of the measurement signals or of signals derived therefrom are compared with items of information from an inspection unit 5 which examines the workpieces downstream.

Yet another feature or aspect of an exemplification is believed at the time of the filing of this patent application to possibly reside broadly in the machine, wherein the machine is configured in such a way that, by the comparison of information items obtained within the framework of the evaluation of the measurement signals or signals derived therefrom with information items from the inspection unit 5, comparison information is obtained, and that, based on the comparison information, an adjustment of the reference signal is carried out.

Still another feature or aspect of an exemplification is believed at the time of the filing of this patent application to possibly reside broadly in the machine, wherein the machine is configured as a container treatment machine, in one possible exemplification as a filling machine, labeling machine, or closer of containers.

The components disclosed in the patents, patent applications, patent publications, and other documents disclosed or incorporated by reference herein, may possibly be used in possible exemplifications of the present invention, as well as equivalents thereof.

The purpose of the statements about the technical field is generally to enable the Patent and Trademark Office and the public to determine quickly, from a cursory inspection, the nature of this patent application. The description of the technical field is believed, at the time of the filing of this patent application, to adequately describe the technical field of this patent application. However, the description of the technical field may not be completely applicable to the claims as originally filed in this patent application, as amended during prosecution of this patent application, and as ultimately allowed in any patent issuing from this patent application. Therefore, any statements made relating to the technical field are not intended to limit the claims in any manner and should not be interpreted as limiting the claims in any manner.

The appended drawings in their entirety, including all dimensions, proportions and/or shapes in at least one exemplification of the invention, are accurate and are hereby included by reference into this specification.

The background information is believed, at the time of the filing of this patent application, to adequately provide background information for this patent application. However, the background information may not be completely applicable to the claims as originally filed in this patent application, as amended during prosecution of this patent application, and as ultimately allowed in any patent issuing from this patent application. Therefore, any statements made relating to the background information are not intended to limit the claims in any manner and should not be interpreted as limiting the claims in any manner.

All, or substantially all, of the components and methods of the various exemplifications may be used with at least one exemplification or all of the exemplifications, if more than one exemplification is described herein.

The purpose of the statements about the object or objects is generally to enable the Patent and Trademark Office and the public to determine quickly, from a cursory inspection, the nature of this patent application. The description of the object or objects is believed, at the time of the filing of this patent application, to adequately describe the object or objects of this patent application. However, the description of the object or objects may not be completely applicable to the claims as originally filed in this patent application, as amended during prosecution of this patent application, and as ultimately allowed in any patent issuing from this patent application. Therefore, any statements made relating to the object or objects are not intended to limit the claims in any manner and should not be interpreted as limiting the claims in any manner.

All of the patents, patent applications, patent publications, and other documents cited herein, and in the Declaration attached hereto, are hereby incorporated by reference as if set forth in their entirety herein except for the exceptions indicated herein.

The summary is believed, at the time of the filing of this patent application, to adequately summarize this patent application. However, portions or all of the information contained in the summary may not be completely applicable to the claims as originally filed in this patent application, as amended during prosecution of this patent application, and as ultimately allowed in any patent issuing from this patent application. Therefore, any statements made relating to the summary are not intended to limit the claims in any manner and should not be interpreted as limiting the claims in any manner.

It will be understood that the examples of patents, patent applications, patent publications, and other documents which are included in this application and which are referred to in paragraphs which state “Some examples of . . . which may possibly be used in at least one possible exemplification of the present application . . . ” may possibly not be used or useable in any one or more exemplifications of the application.

The sentence immediately above relates to patents, patent applications, patent publications, and other documents either incorporated by reference or not incorporated by reference.

Some examples of bottling systems, components of which may be used or adapted for use in at least one possible exemplification of the present application may be found in the following U.S. Pat. Nos., which are incorporated by reference: U.S. Pat. Nos. 4,911,285; 4,944,830; 4,950,350; 4,976,803; 4,981,547; 5,004,518; 5,017,261; 5,062,917; 5,062,918; 5,075,123; 5,078,826; 5,087,317; 5,110,402; 5,129,984; 5,167,755; 5,174,851; 5,185,053; 5,217,538; 5,227,005; 5,413,153; 5,558,138; 5,634,500; 5,713,403; 6,276,113; 6,213,169; 6,189,578; 6,192,946; 6,374,575; 6,365,054; 6,619,016; 6,474,368; 6,494,238; 6,470,922; and 6,463,964.

All of the patents, patent applications, patent publications, and other documents, except for the exceptions indicated herein, which were cited in the German Office Action dated Aug. 14, 2019, and/or cited elsewhere, as well as the German Office Action document itself, are hereby incorporated by reference as if set forth in their entirety herein except for the exceptions indicated herein, as follows: EP 2 108 928, having the title “Device and procedure to monitor the operability of a container treatment device”, published on Oct. 14, 2009; DE 10 2011 011 076, having the title “Method for manufacturing filled container i.e. bottle, from preform, involves relieving molded and filled container in two-stage discharge phase at atmospheric and/or ambient pressure, after completion of forming and filling phase”, published on Aug. 16, 2012; and DE 10 2016 123 695, having the title “Verfahren zur U\ddot{b}erwachung eines Übergabeprozesses”, published on Jun. 7, 2019.

All of the patents, patent applications, patent publications, and other documents, except for the exceptions indicated herein, which were cited in the International Search Report dated Aug. 28, 2018, and/or cited elsewhere, as well as the International Search Report document itself, are hereby incorporated by reference as if set forth in their entirety herein except for the exceptions indicated herein, as follows: US 2014/298100, having title “METHOD FOR OPERATING A CONTAINER TREATMENT SYSTEM WITH FAULT DIAGNOSIS”, published on Oct. 2, 2014; JP 2004093256, having the title “ABNORMALITIES DIAGNOSTIC SYSTEM”, published on Mar. 25, 2004; and US 2014/157726, having the title “METHOD AND DEVICE FOR PRODUCING CONTAINERS WHICH ARE FILLED WITH A LIQUID FILLING SUBSTANCE”, published on Jun. 12, 2014.

The corresponding foreign and international patent publication applications, namely, Federal Republic of Germany Patent Application No. 10 2017 111 066.6, filed on May 22, 2017, having inventors Alexandra THEOPOLD and Wilfried EHMER, and DE-OS 10 2017 111 066.6 and DE-PS 10 2017 111 066.6, and International Application No. PCT/EP2018/215245, filed on May 15, 2018, having WIPO Publication No. WO2018/215245 and inventors Alexandra THEOPOLD and Wilfried EHMER, are hereby incorporated by reference as if set forth in their entirety herein, except for the exceptions indicated herein, for the purpose of correcting and explaining any possible misinterpretations of the English translation thereof. In addition, the published equivalents of the above corresponding foreign and international patent publication applications, and other equivalents or corresponding applications, if any, in corresponding cases in the Federal Republic of Germany and elsewhere, and the references and documents cited in any of the documents cited herein, such as the patents, patent applications, patent publications, and other documents, except for the exceptions indicated herein, are hereby incorporated by reference as if set forth in their entirety herein except for the exceptions indicated herein.

The purpose of incorporating the corresponding foreign equivalent patent application(s), that is, PCT/EP2018/215245 and German Patent Application 10 2017 111 066.6, is solely for the purposes of providing a basis of correction of any wording in the pages of the present application, which may have been mistranslated or misinterpreted by the translator, and to provide additional information relating to technical features of one or more exemplifications, which information may not be completely disclosed in the wording in the pages of this application.

Statements made in the original foreign patent applications PCT/EP2018/215245 and DE 10 2017 111 066.6 from which this patent application claims priority which do not have to do with the correction of the translation in this patent application are not to be included in this patent application in the incorporation by reference.

Any statements about admissions of prior art in the original foreign patent applications PCT/EP2018/215245 and DE 10 2017 111 066.6 are not to be included in this patent application in the incorporation by reference, since the laws relating to prior art in non-U.S. Patent Offices and courts may be substantially different from the Patent Laws of the United States.

All of the references and documents cited in any of the patents, patent applications, patent publications, and other documents cited herein, except for the exceptions indicated herein, are hereby incorporated by reference as if set forth in their entirety herein except for the exceptions indicated herein. All of the patents, patent applications, patent publications, and other documents cited herein, referred to in the immediately preceding sentence, include all of the patents, patent applications, patent publications, and other documents cited anywhere in the present application.

Words relating to the opinions and judgments of the author of all patents, patent applications, patent publications, and other documents cited herein and not directly relating to the technical details of the description of the exemplifications therein are not incorporated by reference.

The words all, always, absolutely, consistently, preferably, guarantee, particularly, constantly, ensure, necessarily, immediately, endlessly, avoid, exactly, continually, expediently, ideal, need, must, only, perpetual, precise, perfect, require, requisite, simultaneous, total, unavoidable, and unnecessary, or words substantially equivalent to the above-mentioned words in this sentence, when not used to describe technical features of one or more exemplifications of the patents, patent applications, patent publications, and other documents, are not considered to be incorporated by reference herein for any of the patents, patent applications, patent publications, and other documents cited herein.

The description of the exemplification or exemplifications is believed, at the time of the filing of this patent application, to adequately describe the exemplification or exemplifications of this patent application. However, portions of the description of the exemplification or exemplifications may not be completely applicable to the claims as originally filed in this patent application, as amended during prosecution of this patent application, and as ultimately allowed in any patent issuing from this patent application. Therefore, any statements made relating to the exemplification or exemplifications are not intended to limit the claims in any manner and should not be interpreted as limiting the claims in any manner.

The details in the patents, patent applications, patent publications, and other documents cited herein may be considered to be incorporable, at applicant's option, into the claims during prosecution as further limitations in the claims to patentably distinguish any amended claims from any applied prior art.

While various aspects and exemplifications have been disclosed herein, other aspects and exemplifications are contemplated. The various aspects and exemplifications disclosed herein are for purposes of illustration and not intended to be limiting. Additionally, the words “including,” “having,” and variants thereof (e.g., “includes” and “has”) as used herein, including the claims, shall be open-ended and have the same meaning as the word “comprising” and variants thereof (e.g., “comprise” and “comprises”).

The purpose of the title of this patent application is generally to enable the Patent and Trademark Office and the public to determine quickly, from a cursory inspection, the nature of this patent application. The title is believed, at the time of the filing of this patent application, to adequately reflect the general nature of this patent application. However, the title may not be completely applicable to the technical field, the object or objects, the summary, the description of the exemplification or exemplifications, and the claims as originally filed in this patent application, as amended during prosecution of this patent application, and as ultimately allowed in any patent issuing from this patent application. Therefore, the title is not intended to limit the claims in any manner and should not be interpreted as limiting the claims in any manner.

The abstract of the disclosure is submitted herewith as required by 37 C.F.R. § 1.72(b). As stated in 37 C.F.R. § 1.72(b):

A brief abstract of the technical disclosure in the specification must commence on a separate sheet, preferably following the claims, under the heading “Abstract of the Disclosure.” The purpose of the abstract is to enable the Patent and Trademark Office and the public generally to determine quickly from a cursory inspection the nature and gist of the technical disclosure. The abstract shall not be used for interpreting the scope of the claims.

Therefore, any statements made relating to the abstract are not intended to limit the claims in any manner and should not be interpreted as limiting the claims in any manner.

The exemplifications of the invention described herein above in the context of the preferred exemplifications are not to be taken as limiting the exemplifications of the invention to all of the provided details thereof, since modifications and variations thereof may be made without departing from the spirit and scope of the exemplifications of the invention.

### AT LEAST PARTIAL NOMENCLATURE

1 Machine
1.1 Inlet star
1.2 Outlet star
2 Rotor
3 Treatment station
4 Sensor
4a First sensor
4b Second sensor
4c Third sensor
5 Inspection unit
6 Evaluation unit
7 Filling valve
8 Container fixing element
9 Container contact element
10 Container fixing device
20.1 Container carrier
20.2 Container holder
21 Closure unit
A Outlet
E Inlet
TR Transport direction
TS Transport path

What is claimed is:

1. A container handling arrangement comprising:
a container filling arrangement being configured to fill containers;
a first transport arrangement comprising a conveyor or star wheel and being configured and disposed to move empty containers to said container filling arrangement;
said container filling arrangement comprising a rotor configured to rotate about a vertical axis;
said rotor comprising a plurality of container holding devices disposed about the perimeter of said rotor;
each of said container holding devices being configured to support and hold a container;
said container filling arrangement comprising a plurality of container filling devices;
each of said container filling devices being configured to fill an empty container with a liquid product;
each of said container filling devices comprising a valve arrangement being configured to be opened to dispense a predetermined volume of liquid product into an empty container, and to be closed upon the predetermined volume of liquid product being dispensed, while said rotor is continuously or stepwise in rotation;
a second transport arrangement comprising a conveyor or star wheel and being configured and disposed to move filled containers out of said container filling arrangement;
a container closing arrangement being configured to close filled containers with a closure comprising a lid, cap, crown cap, or screw cap;
said second transport arrangement being configured and disposed to move filled containers to said container closing arrangement;
said container closing arrangement comprising a rotor configured to rotate about a vertical axis;
said rotor of said container closing arrangement comprising a plurality of container holding devices disposed about the perimeter of said rotor;
each of said container holding devices of said container closing arrangement being configured to support and hold a container;
said container closing arrangement comprising a plurality of container closing devices;
each of said container closing devices being configured to close a filled container with a closure;
each of said container closing devices comprising a movable tooling arrangement being configured to be moved to apply and secure a closure to a filled container by a pressing movement or a rotating movement;
a central control arrangement being operatively connected to each of said container filling arrangement and/or said container closing arrangement;
said central control arrangement being configured to control and monitor the filling and closing of containers by said container filling arrangement and said container closing arrangement; and
said container filling arrangement comprising a plurality of receiving devices disposed at said container filling devices and being configured to receive operating characteristics from the operation of said container filling devices or a portion thereof, and said container closing arrangement comprising a plurality of receiving devices disposed at said container closing devices and configured to receive operating characteristics comprising at least one of an oscillation frequency and an acoustic signal from the operation of said container closing devices and/or from the operation of a portion of said container closing devices, wherein a control arrangement, which is part of or in addition to said central control arrangement, is configured to compare received operating characteristics of said container filling arrangement and/or said container closing arrangement with desired operating characteristics of said container filling arrangement and/or said container closing arrangement to determine the operating states of said container filling arrangement and/or said container closing arrangement.

2. A method of operating a container handling arrangement according to claim 1, said method comprising the steps of:
moving, using said first transport arrangement, empty containers to said container filling arrangement;
rotating said rotor of said container filling arrangement about its vertical axis;
supporting and holding containers with said plurality of container holding devices disposed about the perimeter of said rotor of said container filling arrangement;
filling the empty containers with a liquid product using each of said container filling devices by opening said valve arrangement to dispense a predetermined volume of liquid product into each of the empty containers, and then closing said valve arrangement upon the predetermined volume of liquid product being dispensed, while said rotor is in rotation;
moving, using said second transport arrangement, filled containers out of said container filling arrangement and to said container closing arrangement;
rotating said rotor of said container closing arrangement about its vertical axis;
supporting and holding containers with said plurality of container holding devices disposed about the perimeter of said rotor of said container closing arrangement;
closing the filled containers with a closure using each of said container closing devices by moving said movable tooling arrangement and applying and securing a closure to said filled container; and
controlling and monitoring, using said central control arrangement, said container filling arrangement and/or said container closing arrangement, and comparing, using said control arrangement, received operating characteristics, which operating characteristics comprise at least one of an oscillation frequency and an acoustic signal from the operation of said container filling devices and/or said container closing devices and/or from the operation of a portion of said container filling devices and/or said container closing devices, with desired operating characteristics to determine the operating states of said container filling arrangement and/or said container closing arrangement.

3. A method of operating a container handling arrangement, said container handling arrangement comprising a transport element and a plurality of treatment stations, wherein each of said treatment stations comprises an operating component configured to act directly or indirectly upon a container or part thereof, and wherein said transport element is configured to move containers or parts thereof, during treatment at said treatment stations, on a transport path between a container inlet and a container outlet, and said method comprising the steps of:
moving containers or parts thereof to said container inlet of said container handling arrangement;
holding each of the containers or parts thereof at a corresponding container treatment station;
moving, using said transport element, the containers or parts thereof from said container inlet to said container outlet along said transport path;
while moving the containers or parts thereof along said transport path or a section of said transport path, acting on the containers or parts thereof with said treatment stations or said operating components thereof, and thereby modifying and/or producing the containers or parts thereof, and then detecting, using at least one sensor disposed adjacent or at at least one of said treatment stations or at said operating components, an oscillation frequency and/or an acoustic signal, produced by the treatment or production process at a respective one of said treatment stations and during the transport of the containers or parts thereof at the respective one of said treatment stations, and thereby detecting a pattern, and then evaluating and comparing a measurement signal provided by said at least one sensor or a signal derived therefrom with a reference signal; and
moving containers or parts thereof to said container outlet of said container handling arrangement.

4. The method according to claim 3, wherein the pattern is derived from one or more of said operating components provided at each of said treatment stations and not released from said treatment stations during the entire process.

5. The method according to claim 4, wherein the pattern is derived from a plurality of said operating components comprising identical or essentially identical or similar dimensions and design.

6. The method according to claim 5, wherein the pattern is derived dynamically during a defined period of time from a plurality of said operating components that are comparable or substantially similar to one another.

7. The method according to claim 6, wherein:
the pattern is derived at least due to a location change of said operating components or a part thereof; and/or
the pattern comprises an oscillation frequency and/or an acoustic signal, which is derived from the attaining of an at least temporary end position of at least one of said operating components or a part thereof.

8. The method according to claim 7, wherein:
the pattern comprises an oscillation frequency and/or an acoustic signal, which derives from the spatial location change of at least one of said operating components or a part thereof; and/or
the process comprises several part processes, wherein the patterns derived from these part processes are detected by said sensor or a group of said sensors disposed at a corresponding one of said treatment stations.

9. The method according to claim 8, wherein:
at the different treatment stations in each case the same process steps or the same part processes are carried out in specific regions of the transport path between said container inlet and said container outlet, and/or that at different treatment stations between said container inlet and said container outlet the same process steps or same part processes are carried out staggered in time in relation to one another; and/or
said measurement signals are detected simultaneously at two or more of said treatment stations.

10. The method according to claim 9, wherein:
said reference signal is detected staggered in time in relation to the measurement signals detected at said treatment stations; and/or
said reference signal is initially detected on the basis of several measurement signals detected at different treatment stations.

11. The method according to claim 10, wherein:
the reference signal is detected and/or adjusted intermittently or continuously; and/or
a set of reference signals are stored in a memory, wherein the set of reference signals comprises several reference signals that are dependent on a process parameter.

12. The method according to claim 11, wherein:
the measurement signal or the signal being evaluated with regard to peculiarities indicative of errors is assigned to an angle segment of said transport element, which is in the form of a rotor, and/or to one of said treatment stations and/or to one of the containers or parts thereof; and/or
the reference signal is generated by a mean value formation of the measurement signals or signals derived from them, wherein the measurement signals or the signals derived from them are detected at at least two different treatment stations by said sensors assigned to those treatment stations.

13. The method according to claim 12, wherein:
based on the measurement signal or based on the signal being evaluated with regard to peculiarities indicative of errors is attributed to a part process at one of said treatment stations; and/or
the evaluation is carried out on the basis of measurement signals or signals derived therefrom which are provide by several sensors disposed at one of said treatment stations.

14. The method according to claim 13, wherein:
information items received within the framework of the evaluation of the measurement signals or signals derived from them are compared with information items from an inspection unit examining the containers or parts thereof downstream; and/or
by way of the comparison of the information items received within the framework of the evaluation of the measurement signals or signals derived therefrom with information items from the inspection unit, comparison information items are obtained, and that, based on the comparison information items, an adjustment of the reference signal is carried out.

15. The method according to claim 14, wherein:
based on the evaluation of one or more measurement signals or of a signal derived therefrom, process parameters for said transport element and/or said treatment station are adjusted, and/or maintenance and repair tasks are derived; and/or
reference signals and measurement signals to be compared with these reference signals are detected by a respective sensor of one of said treatment stations in the same transport path section.

16. A container handling arrangement comprising:
a transport element;
a plurality of treatment stations, each comprising an operating component configured to act directly or indirectly upon a container or part thereof;
said transport element being configured to move containers or parts thereof, during treatment at said treatment stations, on a transport path between a container inlet and a container outlet;
said treatment stations and/or said operating component thereof being configured and disposed to act on the containers or parts thereof upon movement of the containers or parts thereof along said transport path or a section of said transport path to thereby modify and/or produce the containers or parts thereof;
at least one sensor being disposed adjacent or at at least one of said treatment stations or said operating components thereof, and being configured to detect an oscillation frequency and/or an acoustic signal produced by the treatment or production process at a respective one of said treatment stations to thereby detect a pattern; and
an evaluation arrangement being configured and disposed to evaluate and compare a measurement signal provided by said at least one sensor or a signal derived therefrom with a reference signal.

17. The container handling arrangement according to claim 16, wherein:
said at least one sensor is disposed at a corresponding treatment station, and said at least one sensor is movable by said transport element, which comprises a rotor; and/or
said sensor comprises at least one contactless sensor or a directional microphone or a laser vibrometer, aligned with or directed toward a corresponding one of said operating components for the measurement of sound and/or vibration.

18. The container handling arrangement according to claim 17, wherein:
each of said treatment stations comprises two or more sensors, which are assigned to different regions of each of said treatment stations; and/or
said container handling arrangement comprises a digital or a physical filter configured to filter out interfering fundamental components of said container handling arrangement and/or interfering background sounds.

19. The container handling arrangement according to claim 18, wherein:
said sensor comprises a surface-borne sound sensor or a microphone; and/or
said evaluation arrangement is configured to:
initially base said reference signal on several measurement signals detected at different treatment stations; and/or
adjust said reference signal is intermittently or continuously.

20. The container handling arrangement according to claim 19, wherein:
said evaluation arrangement comprises a memory storage unit configured to store a set of reference signals, wherein said set of reference signals comprises several reference signals that are dependent on a process parameter; and/or
said container handling arrangement comprises an inspection unit configured to examine containers or parts thereof upon exit from said container outlet, wherein information items obtained within said framework of said evaluation of said measurement signals or of signals derived therefrom are compared with items of information from an inspection unit, which comparison information is used for an adjustment of the reference signal; and/or
said container handling arrangement comprises at least one of: a container filling arrangement, a container labeling arrangement, or a container closing arrangement.
